(19) United States
(12) Patent Application Publication
(10) Pub. No.: US 2012/0242057 A1
(43) Pub. Date: Sep. 27, 2012

(54) VEHICLE WITH HYDRAULICALLY INTERCONNECTED DAMPERS

(75) Inventors: Anthony Richard Glover, Guildford (GB); Paul Andrew Burnham, Surrey (GB)

(73) Assignee: MCLAREN AUTOMOTIVE LIMITED, Working, Surrey (GB)

(21) Appl. No.: 13/498,558

(22) PCT Filed: Sep. 17, 2010
(86) PCT No.: PCT/GB2010/001743

§ 371 Date: Jun. 5, 2012

(30) Foreign Application Priority Data
Oct. 1, 2009 (GB) 0917180.2

(51) Int. Cl. B60G 21/06; B60G 17/08; B60G 17/015; F16F 9/26; B60G 15/06

(52) U.S. Cl. 280/124.158; 188/297; 280/124.161; 280/124.162

(57) ABSTRACT

A damper unit and its employment as part of the suspension system for a vehicle are disclosed. A vehicle of the kind having wheels arranged in left-right pairs has a sprung mass and left and right unsprung masses associated with left and right wheels of a said left-right pair. Respective left and right damper units are mounted between the respective left and right unsprung masses and the sprung mass. Each damper unit has a damper housing defining first and second generally cylindrical chambers therewithin having a common axis. The first and second chambers are separated from each other in the axial direction by an intermediate wall. The first chamber has a first axial end wall at its end remote from the intermediate wall, and the second chamber has a second axial end wall at its end remote from the intermediate wall. A first piston is slidable in sealing engagement with the interior of the first chamber. A second piston is slidable in sealing engagement with the interior of the second chamber. A common damper rod is provided for the first and second pistons, the damper rod being sealingly received through a bore in the first axial end wall, passing axially through the first chamber, and being sealingly received through a bore in the intermediate wall. The respective damper rods of the left and right damper units are arranged for movement into and out of the damper housing as their respective unsprung masses move relative to the sprung mass, the chamber defined between the first piston and the first axial end wall of each damper unit being coupled to the chamber defined between the first piston and the intermediate wall of the other damper unit via at least one restriction, whereby the first chambers of the damper units provide stiffness in roll. Each damper unit is provided with connections between its second chamber and the exterior of the respective damper unit on either side of its second piston to provide coupling for fluid within its second chamber with apparatus external to the damper unit to provide stiffness in heave.

### BACKGROUND

This disclosure relates to wheeled vehicles and to suspension systems therefor.

Suspension systems for vehicles are commonplace, and usually incorporate dampers to smooth the ride. In its travel, a vehicle may be subject to heave, roll, pitch and warp; and suspension systems may accordingly employ a plurality of dampers, including hydraulic dampers, for damping or for contributing to stiffness in one or more of heave, roll, pitch and warp. The dampers often co-operate with helical, coach or torsion springs providing the primary suspension, the dampers serving to damp the motion of the spring suspension.

As will become clear from the detailed description below, we have devised a single damper unit that, with suitable connections between the chambers of similar such single damper units associated with each of the four wheels of a vehicle, can provide for independent stiffness and damping both for heave and roll.

### SUMMARY

In accordance with a first aspect of this disclosure, a damper unit comprises: a damper housing defining first and second generally cylindrical chambers therewithin having a common axis, the first and second chambers being separated from each other in the axial direction by an intermediate wall, the first chamber having a first axial end wall at its end remote from the intermediate wall, and the second chamber having a second axial end wall at its end remote from the intermediate wall; a first piston slidable in sealing engagement with the interior of the first chamber; connections between the first chamber and the exterior of the damper unit on either side of the first piston to provide coupling for fluid within the first chamber with apparatus external to the damper unit; a second piston slidable in sealing engagement with the interior of the second chamber; connections between the second chamber and the exterior of the damper unit on either side of the second piston to provide coupling for fluid within the second chamber with apparatus external to the damper unit; and a common damper rod for said first and second pistons, the damper rod being sealingly received through a bore in the first axial end wall, passing axially through said first chamber, and being sealingly received through a bore in the intermediate wall.

In a second and alternative aspect of this disclosure, a vehicle of the kind having wheels arranged in left-right pairs, comprises: a sprung mass; left and right unsprung masses associated with left and right wheels of a said left-right pair; and respective left and right damper units mounted between the respective left and right unsprung masses and the sprung mass, each said damper unit comprising: a damper housing defining first and second generally cylindrical chambers therewithin having a common axis, the first and second chambers being separated from each other in the axial direction by an intermediate wall, the first chamber having a first axial end wall at its end remote from the intermediate wall, and the second chamber having a second axial end wall at its end remote from the intermediate wall; a first piston slidable in sealing engagement with the interior of the first chamber; a second piston slidable in sealing engagement with the interior of the second chamber; and a common damper rod for said first and second pistons, the damper rod being sealingly received through a bore in the first axial end wall, passing axially through said first chamber, and being sealingly received through a bore in the intermediate wall; the respective damper rods of the left and right damper units being arranged for movement into and out of the damper housing as their respective unsprung masses move relative to the sprung mass, the chamber defined between the first piston and the first axial end wall of each damper unit being coupled to the chamber defined between the first piston and the intermediate wall of the other damper unit via at least one restriction, whereby the first chambers of the damper units provide stiffness in roll; each damper unit being provided with connections between its second chamber and the exterior of the respective damper unit on either side of its second piston to provide coupling for fluid within its second chamber with apparatus external to the damper unit to provide stiffness in heave.

The fluid in the first and/or second chambers may be pneumatic or hydraulic. If hydraulic, each hydraulic circuit may include an accumulator. With a pneumatic system, no accumulator may be required, the gas being accommodated throughout the system.

Corresponding chambers defined on opposite sides of the respective second pistons of the left and right damper units are preferably coupled via at least one restriction.

In a four wheeled vehicle, the unsprung mass associated with each wheel preferably has its own damper unit. The chambers defined on either side of the second pistons of the damper units associated with the respective front wheels may be coupled to the chambers defined on the opposite sides of the second pistons of the damper units associated with the respective rear wheels, thereby providing stiffness in pitch.

The respective restrictions are preferably damper valves, which may provide a constant passive restriction or may be semi-active, for example with electronic control, thereby providing variable damping.

### BRIEF DESCRIPTION OF THE DRAWINGS

Reference is now made to the accompanying drawings, in which:

FIG. 1 is a generally schematic view of a damper unit;

FIG. 2 is a generally schematic view illustrating how the damper unit of FIG. 1 may be incorporated into a double wishbone suspension; and

FIG. 3 shows a schematic hydraulic circuit diagram linking respective damper units associated with the front and rear wheels of a four wheeled vehicle.

### DESCRIPTION OF PREFERRED EMBODIMENTS

Although the teachings of this disclosure may be applied to any vehicle of the kind having wheels arranged in left-right pairs, in practice the great majority of such vehicles will be four-wheeled. The damper unit is also believed novel per se. The description hereinbelow is written in terms of a four-wheeled vehicle having front and rear suspension systems. Persons skilled in this art will readily appreciate from this description how the present teachings may be applied to vehicles with more than four wheels or with just one left-right pair, for example a three-wheeled vehicle.

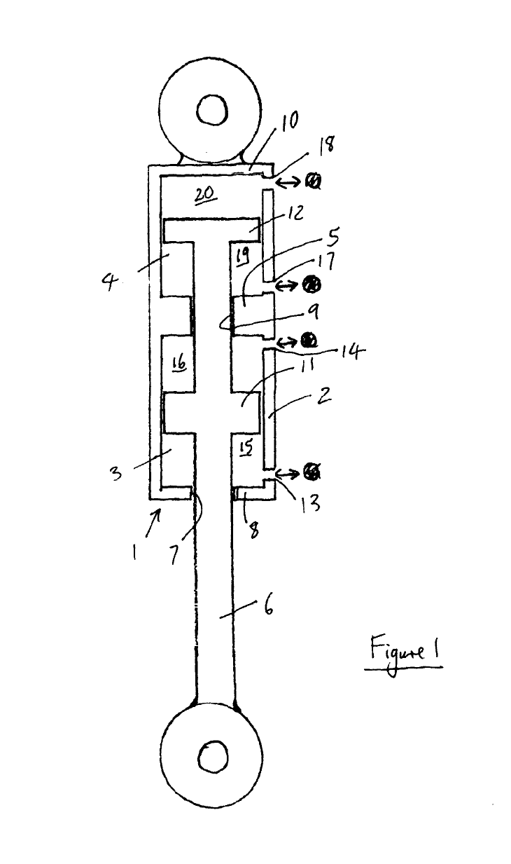

Referring to FIG. 1, a damper unit 1 comprises: a damper housing 2 defining a first generally cylindrical chamber 3 and a second generally cylindrical chamber 4. The two chambers have a common axis, and, as shown, have the same cross-sectional area, although this is not necessary. The first and second chambers are separated from each other in the axial direction by an intermediate wall 5. The two chambers have a common damper rod 6. The damper rod 6 passes through a bore 7 in a first axial end wall 8 in the first chamber 3 at its end remote from the intermediate wall 5, and also passes through a bore 9 in the intermediate wall 5 into the second chamber, which has a closed second axial end wall 10 at its end remote from the intermediate wall 5. The damper rod is coupled to a first piston 11 in the first chamber 3 and a second piston 12 in the second chamber 4. As indicated schematically in FIG. 1, ports 13 and 14 are provided to chamber 3 for communication with spaces 15 and 16 on either side of piston 11, and ports 17 and 18 are provided to chamber 4 for communication with the spaces 19 and 20 on either side of piston 12, thereby providing for communication for fluid within the respective first and second chambers on either side of their pistons with apparatus external to the damper unit.

It will be appreciated that there will be sliding seals where damper rod 6 passes through bores 7 and 9, and that the pistons 11 and 12 will also be provided with sliding seals with the internal surfaces of chambers 3 and 4. The details of these seals are not of importance for the present disclosure, and they have all been omitted from the drawings for economy of draughtsmanship. Similarly, the pistons 11 and 12 will in practice be provided as separate components that are fastened to the damper rod, but, again, the precise way this is achieved is not of any importance for the present disclosure. In practice, the damper housing will also be formed from several components that are assembled together to create and define the internal chambers 3 and 4. The precise way this is achieved is again of no significance for the present disclosure. All of the above manufacturing details will be within the competence of a person of ordinary skills in this field without need for further instruction.

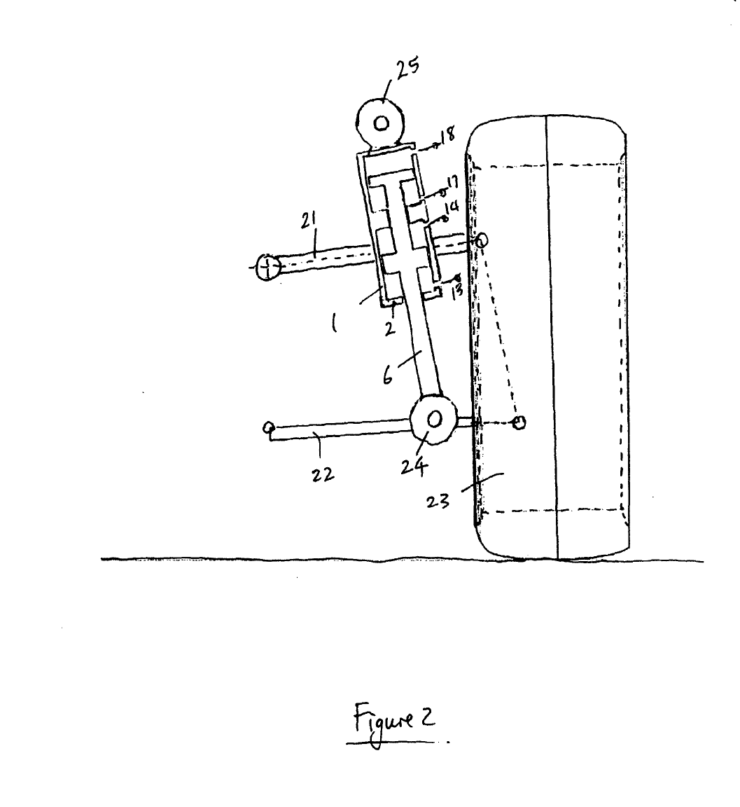

FIG. 2 shows how the damper unit 1 of FIG. 1 may be employed in a typical suspension, here a double wishbone suspension indicated only schematically, with upper 21 and lower 22 arms coupled between a wheel 23 and a sprung mass, not shown. The damper rod of unit 1 is coupled at its distal end 24 to the unsprung mass associated with wheel 23, while damper housing 2 is coupled at its end 25 remote from the damper rod to the sprung mass. As a result, the damper rod 6 will move into and out of the damper housing 2 as the unsprung mass moves relative to the sprung mass. Damper unit 1 may also be employed in other configurations of suspension. In each case, it may serve as a replacement for a conventional damper unit. Employment of damper unit 1 may negate the need for springs to support the static weight of the sprung mass since the static vertical force and the vertical stiffness may be provided by hydraulic circuits coupled to the ports.

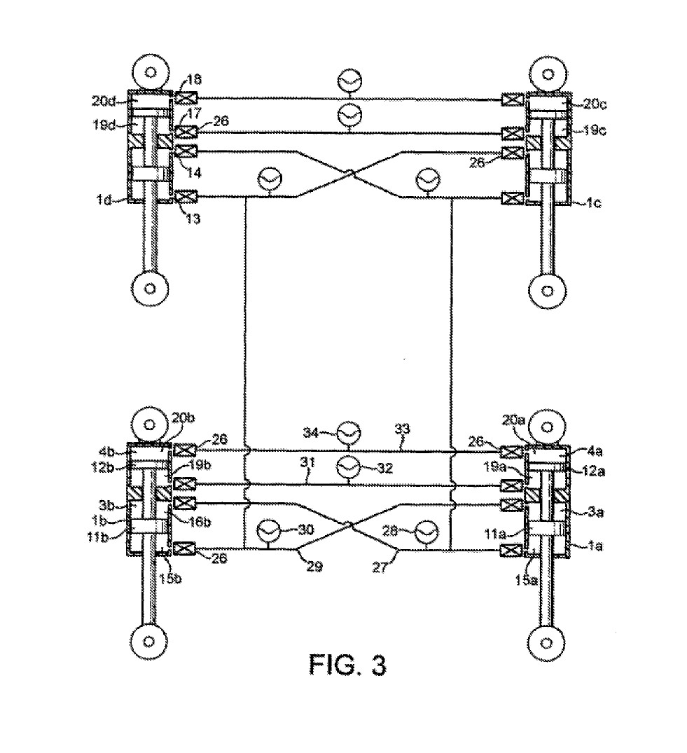

A typical hydraulic circuit arrangement to provide roll and heave stiffness employing damper units 1 at each of four wheels of a vehicle is illustrated in FIG. 3. Damper units 1a and 1b are associated respectively with the left and right front wheels, while damper units 1c and 1d are associated respectively with the left and right rear wheels. The letters a, b, c and d are used to distinguish between equivalent chambers of the respective damper units. In the illustrated circuit arrangement, a restriction in the form of a damper valve 26 is provided at each port 13, 14, 17 and 18 of each damper unit, but the system will work satisfactorily with fewer such restrictions provided that each hydraulic line connecting ports of two different damper units includes a restriction therein. The damper valves 26 may be passive or may be semi-active, with electronic control to vary the extent of restriction.

As shown, an hydraulic line 27 with an accumulator 28 is coupled between chamber 15a on one side of piston 11a of damper unit 1a and chamber 16b on the opposite side of piston 11b of damper unit 1b, and a similar hydraulic line 29 with an accumulator 30 is coupled between chamber 15b on one side of piston 11b of damper unit 1b and chamber 16a on the opposite side of piston 11a of damper unit 1a. The first chambers 3a and 3b will provide stiffness for roll with this arrangement. The chambers 4a and 4b provide stiffness for heave. The respective chambers 19a and 19b on the intermediate wall side of pistons 12a and 12b are coupled together by an hydraulic line 31 including an accumulator 32, while chambers 20a and 20b on the second axial end wall side of pistons 12a and 12b are similarly coupled together by an hydraulic line 33 including an accumulator 34.

That the surface area of each piston 12 on the second axial end wall side thereof is greater than that on the other side thereof is beneficial as this will produce a net vertical force when there is equal pressure in the two chambers on opposite sides of the piston 12. This helps to support the static weight of the sprung mass. Such support may be provided by heave chambers 4 alone or together with mechanical springs. Selection as between damper units with damper rods of different diameter will therefore tune the stiffness achieved and extent of support. The roll chambers 3 have equal surface areas on opposite sides of their pistons 11 so that there is zero net force in a zero roll condition.

As shown the four hydraulic circuits associated with the respective heave chambers are independent of each other, while each hydraulic circuit associated with the roll chambers for the front wheels is coupled to the equivalent circuit for the rear wheels. As a result, there is very low or zero stiffness in warp. The stiffness of the several accumulators define the suspension stiffness for each suspension mode. These may be independently controllable. With common bore and rod diameters in the four damper units, the warp stiffness of the vehicle will be zero. Warp, heave and roll stiffness balance front-to-rear can be altered by varying these parameters.

Static ride height at the front and rear of the vehicle may be independently adjusted by pumping hydraulic fluid from heave bump hydraulic circuit 33 to heave rebound hydraulic circuit 31 and vice-versa. For both the heave and roll circuits, stiffness may be adjusted by pumping hydraulic fluid equally into the respective hydraulic circuits to compress gas or air in the accumulators to adjust their spring rate.

The diameters of the roll and heave chambers, and thus of their respective pistons need not be identical as illustrated, but may be chosen to optimise the roll and heave stiffness independently.

Anti-roll bars could be employed in addition to the roll stiffness provide by the damper units, or on one axle only.

The front and rear heave circuits may be coupled to provide stiffness in pitch, but there is some compromise with heave stiffness. In this arrangement, chambers 19a and 19b are coupled to chambers 20c and 20d respectively, while chambers 20a and 20b are coupled to chambers 19c and 19d respectively. In a variant, if mechanical springs are employed as the principal factor controlling heave stiffness, the coupled front and rear heave circuits will primarily serve to control pitch stiffness.

In a further variation of the described arrangement, one or more of the hydraulic circuits may be replaced by a pneumatic circuit. A benefit of this arrangement is that the pneumatic circuits do not require accumulators as the pneumatic volume can be accommodated through the whole circuit of chambers and pipework. Use of hydraulic circuits for roll and pneumatic circuits without need for accumulators for heave provides good results, since the roll circuit also displaces fluid in heave and warp, so that the hydraulic damper valves of the roll circuit can also be used to damp heave and warp motions.

1. A damper unit comprising: a damper housing defining first and second generally cylindrical chambers therewithin having a common axis, the first and second chambers being separated from each other in the axial direction by an intermediate wall, the first chamber having a first axial end wall at its end remote from the intermediate wall, and the second chamber having a second axial end wall at its end remote from the intermediate wall; a first piston slidable in sealing engagement with the interior of the first chamber; connections between the first chamber and the exterior of the damper unit on either side of the first piston to provide coupling for fluid within the first chamber with apparatus external to the damper unit; a second piston slidable in sealing engagement with the interior of the second chamber; connections between the second chamber and the exterior of the damper unit on either side of the second piston to provide coupling for fluid within the second chamber with apparatus external to the damper unit; and a common damper rod for said first and second pistons, the damper rod being sealingly received through a bore in the first axial end wall, passing axially through said first chamber, and being sealingly received through a bore in the intermediate wall.

2. A vehicle of the kind having wheels arranged in left-right pairs, comprising: a sprung mass; left and right unsprung masses associated with left and right wheels of a said left-right pair; and respective left and right damper units mounted between the respective left and right unsprung masses and the sprung mass, each said damper unit comprising: a damper housing defining first and second generally cylindrical chambers therewithin having a common axis, the first and second chambers being separated from each other in the axial direction by an intermediate wall, the first chamber having a first axial end wall at its end remote from the intermediate wall, and the second chamber having a second axial end wall at its end remote from the intermediate wall; a first piston slidable in sealing engagement with the interior of the first chamber; a second piston slidable in sealing engagement with the interior of the second chamber; and a common damper rod for said first and second pistons, the damper rod being sealingly received through a bore in the first axial end wall, passing axially through said first chamber, and being sealingly received through a bore in the intermediate wall; the respective damper rods of the left and right damper units being arranged for movement into and out of the damper housing as their respective unsprung masses move relative to the sprung mass, the chamber defined between the first piston and the first axial end wall of each damper unit being coupled to the chamber defined between the first piston and the intermediate wall of the other damper unit via at least one restriction, whereby the first chambers of the damper units provide stiffness in roll; each damper unit being provided with connections between its second chamber and the exterior of the respective damper unit on either side of its second piston to provide coupling for fluid within its second chamber with apparatus external to the damper unit to provide stiffness in heave.

3. A vehicle according to claim 2, wherein corresponding chambers defined on opposite sides of the respective second pistons of the left and right damper units are coupled via at least one restriction.

4. A four-wheeled vehicle according to claim 2, wherein a respective said damper unit is provided for the unsprung mass associated with each wheel, and wherein the chambers defined on either side of the second pistons of the damper units associated with the respective front wheels are coupled via at least one restriction to the chambers defined on the opposite sides of the second pistons of the damper units associated with the respective rear wheels, thereby providing stiffness in pitch.

5. A vehicle according to claim 4, further comprising mechanical springs to provide the principal stiffness in heave.

6. A vehicle according to claim 2, wherein the static weight of the sprung mass is supported via the second chambers without additional mechanical springs.

7. A vehicle according to any of claim 2, wherein the fluid in the first chambers is hydraulic and the fluid in the second chambers is pneumatic, and the couplings between chambers do not include any accumulators, the pneumatic volume being accommodated through the chambers and couplings, and hydraulic damping provided by restrictions effectively providing the compliance of an accumulator without need for one.

8. A vehicle according to any of claim 2, wherein the at least one restriction is semi-active with electronic control, thereby providing variable damping.
